(19) United States
(12) Patent Application Publication
(10) Pub. No.: US 2004/0133493 A1
(43) Pub. Date: Jul. 8, 2004

(54) Method and system for comprehensive real estate transaction management

(76) Inventors: Timothy K. Ford, Austin, TX (US); Peter K. Jang, Austin, TX (US); John F. Kennedy, Austin, TX (US)

Correspondence Address: William D. Wiese, Jenkens & Gilchrist, P.C., Suite 3200, 1445 Ross Avenue, Dallas, TX, 75202, US

(21) Appl. No.: 10/699,807

(22) Filed: Nov. 3, 2003

Related U.S. Application Data
(60) Provisional application No. 60/423,511, filed on Nov. 4, 2002.

(51) Int. Cl. G06F 17/60

(52) U.S. Cl. 705/35

(57) ABSTRACT

A method and system for comprehensively managing real estate transactions through a network from inception of a sale or purchase through listing, purchasing, closing and post-closing activity. Participants or potential participants in a real estate transaction can access, generate, modify, distribute and sign real estate-related documents, information, and reports through a network while communicating with each other electronically. Participants or potential participants can also track the development of a real estate transaction and receive automatic notification of changes in the development. Access to the system's various features can also be restricted to certain transaction participants or potential participants.

### PRIORITY STATEMENT UNDER 35 U.S.C. § 119 & 37 C.F.R. § 1.78

This non-provisional application claims priority based upon prior U.S. Provisional Patent Application Serial No. 60/423,511 filed Nov. 4, 2002 in the name of Timothy K. Ford, entitled “SYSTEM FOR COMPREHENSIVE REAL ESTATE TRANSACTION MANAGEMENT.”

### BACKGROUND OF THE INVENTION

1. Technical Field of the Invention

The present invention relates generally to a method and system for real estate transaction management through a network. More particularly, the present invention relates to a comprehensive, collaborative system for managing activities related to real estate transactions from inception of a sale or purchase of real estate through listing, purchasing, closing and post-closing activities.

2. Description of Related Art

The process of purchasing or selling real estate is, in general, the same from transaction to transaction. For example, a seller will typically enter into a representation agreement with an agent. The seller's agent will then list the real estate for sale after conducting a comparative market analysis to price the property. Similarly, a buyer may enter into a representation agreement with an agent. The buyer's agent will aid the buyer in searching listings to identify real estate to purchase. Once the buyer has chosen real estate to purchase, the buyer's agent will draft, and the buyer will sign, an offer to purchase the real estate. The buyer and the seller may negotiate this offer. If the seller accepts the offer, then the seller will sign the offer agreement.

Agreements to purchase real estate are typically contingent upon a number of factors such as the buyer's inspection of the property, the buyer's ability to obtain financing, insurance, and a clear title, and a satisfactory appraisal of the value of the real estate. If these factors are completed satisfactorily, then the transaction may proceed to closing. Often, the closing of a real estate transaction involves the preparation, review and signing of a number of legal documents along with the ultimate transfer of title to the real estate from the seller to the buyer. Further, all of the transaction participants must typically travel to one location for the closing. After closing, secondary mortgage lenders may review these documents in order to purchase mortgages.

Existing systems for managing real estate transactions within the real estate industry are typically limited to only a few of these tasks. In particular, existing systems are either suited to address tasks associated with listing real estate or tasks associated with handling numerous closing documents. There is a need, therefore, for a centralized, online system for managing the entire real estate transaction process from the inception of a sale or purchase of real estate through the listing, purchasing, closing and post-closing activity.

### SUMMARY OF THE INVENTION

The present invention addresses the need for a centralized, online, system for managing real estate transactions from inception of a sale or purchase of real estate through listing, purchasing, closing and post-closing activities. The present invention provides a system for comprehensively managing a real estate transaction consisting of a real estate multiple-listing system, a system for managing real estate purchases, a system for managing real estate closings, a system for managing post-closing activities and a method for accessing each of these systems through a network.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a general flow diagram showing the preferred system for managing real estate transactions;

FIG. 2 is a flow diagram showing a method for managing the pre-listing process in a real estate multiple-listing system;

FIG. 3 is a flow diagram showing a method for managing the buyer pre-qualification process in a real estate multiple-listing system;

FIG. 4 is a flow diagram showing a method for managing the listing process in a real estate multiple-listing system;

FIG. 5 is a flow diagram showing a method for managing the buying process in a real estate multiple-listing system;

FIG. 6 is a flow diagram showing a method for managing the contract process in a system for managing real estate purchases;

FIG. 7 is a flow diagram showing a method for managing a real estate transaction as a role-based transaction;

FIG. 8 is a flow diagram showing a method for managing real estate closings;

FIG. 9 is a flow diagram showing a method for managing post-closing activity;

FIG. 10 is screen from a graphical user interface for the listing process shown in FIG. 6; and

FIG. 11 is a flow diagram showing how the method is integrated into the transaction process.

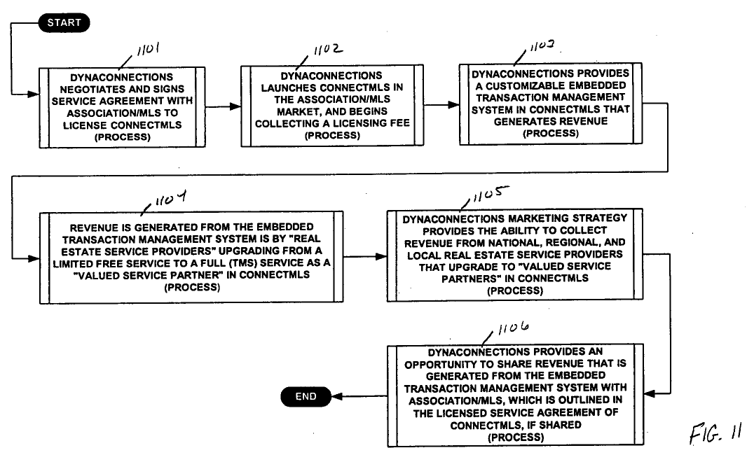

### DETAILED DESCRIPTION OF THE EXEMPLARY EMBODIMENTS OF THE INVENTION

The numerous innovative teachings of the present application will be described with particular reference to the presently preferred exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others.

The present invention provides a centralized, online, system for managing the entire real estate transaction process from the inception of a sale or purchase of real estate through the listing, purchasing, closing and post-closing activity. The present invention provides a system for comprehensively managing a real estate transaction consisting of a real estate multiple-listing system, a system for managing real estate purchases, a system for managing real estate closings, a system for managing post-closing activities and a method for accessing each of these systems through a network. The network may be a global communications network such as the Internet, an intranet, a wireless network, a wide area network, a local area network or a point-to-point connection. Participants or potential participants in a real estate transaction can access, generate, modify, distribute and sign real estate-related documents, information, and reports through a network while communicating with each other electronically. Participants or potential participants can also track the development of a real estate transaction and receive automatic notification of changes in the development. Access to each of the features can also be restricted to certain transaction participants or potential participants.

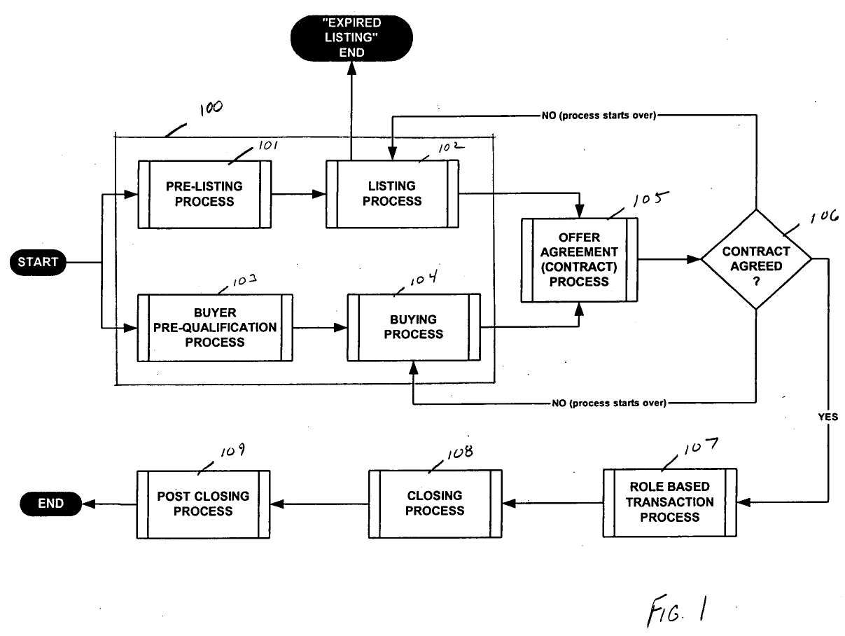

The preferred method for comprehensive real estate management is shown in FIG. 1. A real estate multiple-listing system 100 includes the prelisting process 101, the listing process 102, the buyer pre-qualification process 103 and the buying process 104. A seller first enters the prelisting process 101 and then proceeds to the listing process 102. The pre-listing and listing processes allow for a seller to receive offers of purchase for the seller's real estate. At the same time, a buyer first enters the buyer pre-qualification process 103 and then proceeds to the buying process 104. The pre-qualification and buying processes allows a buyer to make an offer for real estate listed by a seller. A method for managing real estate purchases is illustrated by the contract process 105. When a buyer makes an offer and a seller accepts, a purchase contract is formed 106. Upon the formation of a purchase contract, the contract process 105 allows the participants in the transaction to track the development of the transaction through the role-based transaction process 107. A method for managing real estate closings is illustrated by the closing process 108. Finally, a method for managing post closing activities is illustrated by the post closing process 109.

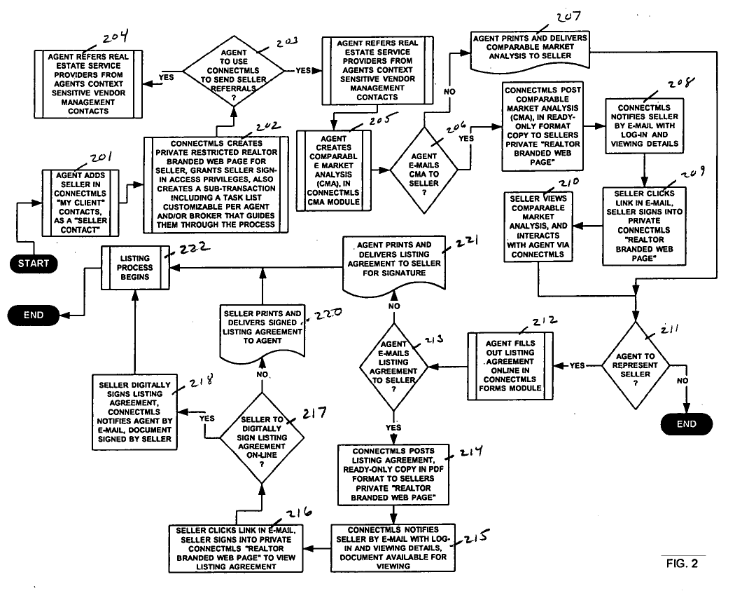

A method for managing the prelisting process 101 of a real estate multiple-listing system 100 is shown in FIG. 2. The method allows an agent to add seller contact information to the system 201, create a private webpage for the seller 202 and grant the seller sign-in access privileges to the system 202. In addition, a task list is created that provides the participants with the ability to see the progress that has been made to date, as well as the items that need to be completed, in a list format. This task list is a particularly novel aspect of the present invention in that it provides a visual summary of the tasks remaining in the transaction, thereby serving as a guide for the participants in completing the transaction. Referral information can also be sent to the seller 203. More specifically, an agent may make referrals to the real estate service providers the agent has stored in the agent's vendor contact list on the system 204. The method also provides the agent with the ability to create a comparable market analysis for the seller's real estate 205. The comparable market analysis can be, for example, electronically sent to the seller 206. Alternatively, an agent can print and physically deliver the comparable market analysis to the seller 207. If an agent elects to deliver a comparable market analysis to a seller electronically, the agent can contact the seller with log-in information and details for viewing the analysis on the system 208. The seller may simply click on a link in the email and sign into the system 209 in order to view the comparable market analysis. When viewing the comparable market analysis, the seller may electronically interact with the agent through the system 210.

The method also provides a process for an agent to represent a seller 211. For example, an agent may use various agreement forms on the system to fill out a listing agreement online 212. An agent can elect whether to email the listing agreement to the seller 213 or print out and physically deliver the listing agreement to the seller for the seller's written signature 221. If an agent elects to email a listing agreement to a seller, the agreement can be posted in a read only format to the seller's private webpage on the system 214. The seller can be notified by email to inform the seller that the document is available for viewing 215. The seller can simply click on a link in the email, sign into the system and view the listing agreement 216. The seller then has the option to digitally sign the listing agreement through a network 217. In this context, a digital signature could be any type of signature or other manifestation of assent transmitted electronically. If the seller prefers to sign the agreement by hand, the seller can print, sign and deliver the listing agreement to the agent 220. Alternatively, the seller may digitally sign the listing agreement wherein the agent is notified by email that the agreement is signed 218. Once the listing agreement is signed, the agent adds a new listing for the real estate to the system thereby ending the prelisting process 222.

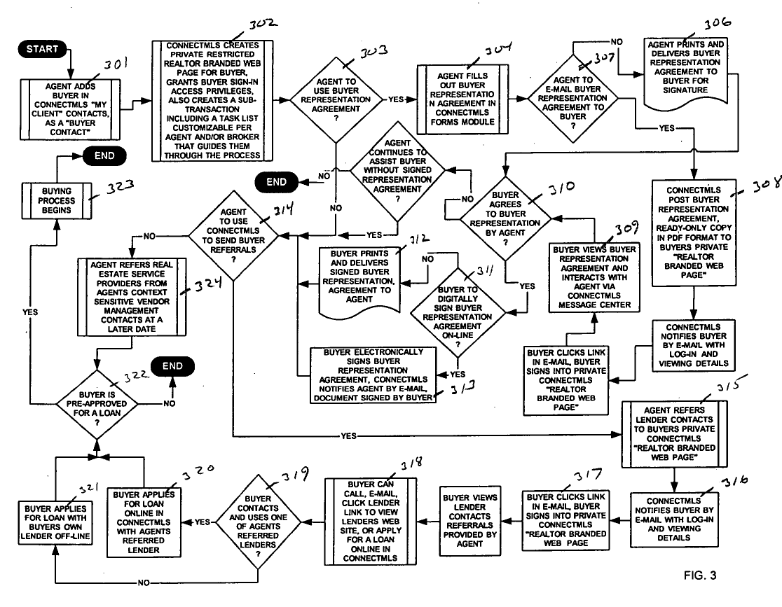

A method for managing the buyer pre-qualification process 103 of a real estate multiple-listing system 100 is illustrated in FIG. 3. An agent first adds a buyer's contact information to the system 301. An agent may also create a private webpage for a buyer and grant a buyer sign-in access privileges to the system 302. In addition, the participants have the ability to see the progress that has been made to date, as well as the items that need to be completed, in a list format. An agent can send referrals to a buyer 314 before or after electing to enter into a representation agreement with the buyer 303. To enter into a representation agreement, an agent may simply electronically fill out a buyer's representation agreement using a form on the system 304. The agent can also post a buyer representation agreement to the buyer's private webpage in a read only format 305. The agent can elect to deliver the buyer representation agreement to the buyer 307 electronically or print out and physically deliver the agreement to the buyer for the buyer's written signature 306. If, for example, an agent elects to deliver the agreement by email, the agent can add detailed log-in and viewing information to the email 308. The buyer can then simply click on a link in the email, sign into the system and view the buyer representation agreement on line 309. The buyer may also interact with the agent while viewing the buyer representation agreement online 309. The buyer may also execute the buyer representation agreement on-line 310 by digitally signing the agreement 311. If the buyer digitally signs the buyer representation agreement, the system automatically notifies the agent by email 313. Alternatively, the buyer can elect to print, sign and physically deliver the buyer representation agreement 312. The agent can also send real estate referrals to the buyer 314. In this context, real estate referrals may be lenders, title companies, remodelers or other parties that provide real estate-related services. For example, the agent may refer lenders to the buyer by posting lender information to the buyer's private webpage 315. In such an event, the system will automatically send an email to the buyer with login and viewing details 316. The buyer then simply clicks on a link in the email, signs into the system and views the lender referrals provided by the agent 317. The buyer can then email a lender, call a lender, link to a lender's webpage or apply for loans on-line 318. The system also provides the buyer a choice 319 of applying for a loan on-line using a lender referred by the system 320 or applying for a loan 321 through another lender. If the buyer is pre-approved for a loan 322, the buying process may begin 323. An agent may also elect to refer real estate service providers to the buyer from the agent's vendor contacts on the system 324. If the buyer is not pre-approved for a loan, then the process may, instead, end.

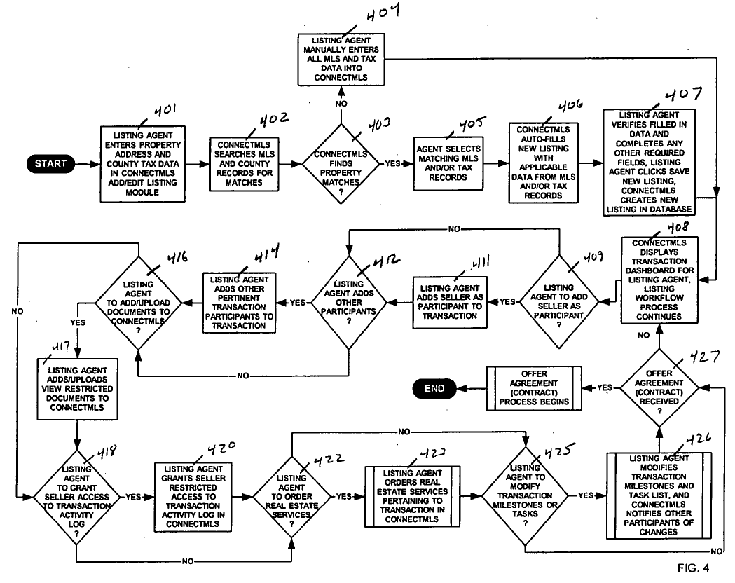

A method for managing a listing process 102 of a real estate multiple-listing system 100 is shown in FIG. 4. First, an agent is allowed to enter the address or county tax information of real estate into the system 401. The agent may also search MLS or county records for information that matches the address and county tax information inputted by the agent 402. If there are multiple matches 403, an agent may select from the matching MLS, county records or both 405. The system will then automatically generate listing information for the real estate from the information provided in the MLS, county records or both 406. The agent may then verify the generated data and complete any other required information before listing the real estate. The system allows an agent to create and save new listing information on the system 407. Alternatively, if there are no property matches, the agent may manually enter all of the MLS or county records into the system to create a listing 404. In either case, the agent and other participants in the transaction can monitor and track the development of the listing as it evolves into a contract for purchase through the display of a transaction dashboard 408. The agent may also elect to add the seller as a transaction participant 409 or decide to add the seller as a participant to the transaction at another time. If the agent does add the seller as a participant to the real estate transaction 411, the agent may also decide to add other participants 412. The agent may also add other participants to the transaction 414 or add other participants at another time. The agent has the ability to upload documents into the system 416. The system restricts the viewing rights of the document, however, to the listing agent that uploaded them 417. The agent may grant the seller access to view the documents or the agent may grant the seller access to the transaction activity log 420, or the agent may decide to grant the seller access at another time. In addition, the agent may order real estate services pertaining to the real estate transaction 423. Finally, the agent can update the development of the real estate transaction 426. This listing process may continue until an offer is received from a buyer 427.

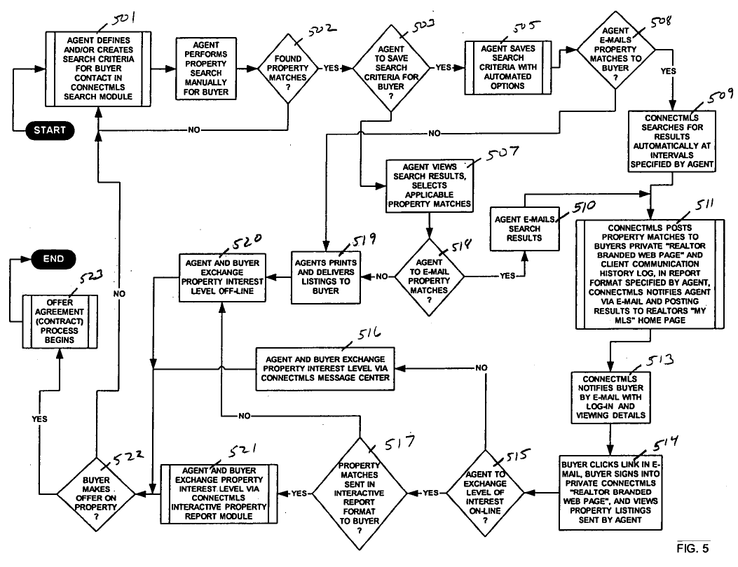

As shown in FIG. 5, one method for managing the buying process 104 of a real estate multiple-listing system 100 is illustrated. The agent can create search criteria based on a buyer's contact information 501. The agent can then search real estate listings to identify matches between the listings and the defined search criteria 502. The agent can save the search criteria for the buyer 503 and perform property searches manually 504. In such cases, the agent can view search results on the system and select applicable property matches 507. The agent may then notify the buyer of the property matches 518, or print and deliver the matches to the buyer 519. Alternatively, the agent can perform automated searches based on the buyer's search criteria 509 where the agent saves search criteria for the buyer 505, and delivers the property listings to the buyer 508 electronically. The agent may send these search results to the buyer 510. The agent can post the search results to the buyer's webpage in a read-only format or in an interactive report format 511. In either case, when a search report is posted to the buyer's private webpage, the buyer then receives an email notification with log-in and viewing details 513. The buyer can then click on a link in the email, sign into the system and view the property listings from the search results 514. If the buyer sees the report in read-only format 515, then agent and buyer may still exchange property interest information on-line 516. If the buyer receives the search result information in an interactive report format 515, then the agent and buyer may elect 517 to exchange property interest on-line through the system 521 or off-line 520. The buyer then may decide whether or not to make an offer on the property 522. If so, then the contract phase begins 523.

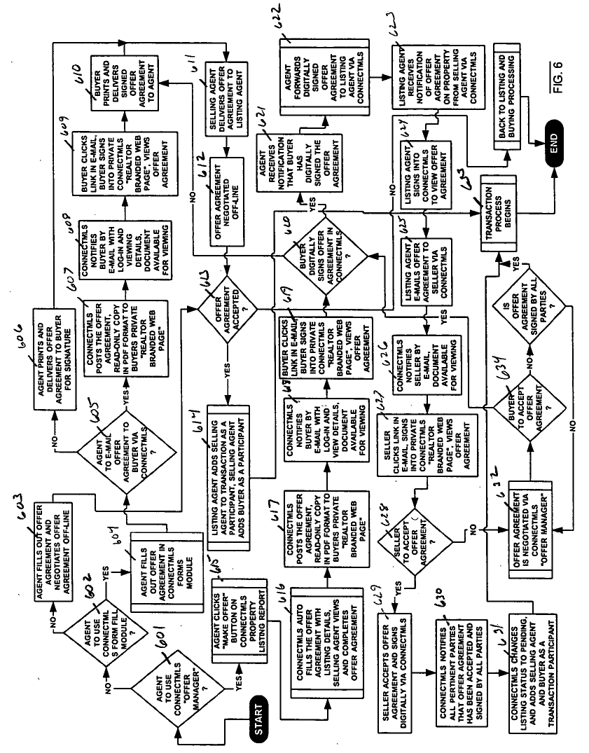

A method for managing the contract process 105 is shown in FIG. 6. The agent first completes an offer agreement 604, delivers the offer agreement to the buyer 605 electronically, and posts the offer agreement to the buyer's private webpage in a read-only format 607. The buyer is automatically notified by email that the document is available for viewing 608. The buyer can then click on a link in the email, sign into the system and view the offer agreement 609. Upon viewing the offer agreement, the buyer can then print, sign and deliver the offer agreement to his agent 610. In turn, buyer's agent can then deliver the offer agreement to the seller's agent 611 and begin off-line negotiations between the buyer, the seller and their respective agents 612. If the seller decides to accept the offer 613, the seller's agent can add the buyer and the buyer's agent as participants in the real estate transaction 614. Once the buyer and the buyer's agent are added to the transaction, the transaction process begins 633.

If desired by the agent, an offer agreement is automatically generated by the system 601, whereby the buyer's agent clicks on a button 615 and the system will automatically generate an offer agreement based on the listing details of the real estate that the buyer's agent chooses 616. Buyer's agent then has a chance to review and complete the offer agreement 616. Once the buyer's agent has completed the offer agreement, the completed offer agreement is posted to the buyer's private webpage 617. In addition, the buyer is notified by email that the document is available for viewing 618. The buyer may then click on a link in the email, sign into the system and view the offer agreement 619. The buyer also has the ability to digitally sign the offer agreement on-line through the system 620. In the context of this document, digital signature means any signature on manifestation of assent that is transmitted electronically. Once the buyer signs the offer agreement, the agent will automatically receive notification that the buyer has digitally signed the offer agreement 621. The agent then forwards the digitally-signed offer agreement to the seller's agent through the system 622. The listing agent will receive notification of the offer agreement on the property 623 and sign into the system to view the offer agreement 624. The seller's agent may then email the offer agreement to the seller through the system 625 and the system will automatically notify the seller that the offer agreement is available for viewing 626. To access the document, the seller can click on a link in an email, sign into the system and view the offer agreement 627. The seller can reject the offer agreement 628 and negotiate or counteroffer 632. The buyer can then decide whether to accept a counter offer, reject a counter offer or otherwise continue negotiations 634. The seller may also decide to accept the offer 628 by digitally signing the offer agreement 629. If the seller accepts the offer agreement then the system notifies all pertinent parties that the offer agreement has been signed 630. In addition, the listing status of the real estate may be changed and the buyer and the buyer's agent may be added as transaction participants to the real estate transaction 631. Once this step is complete, the contract phase ends and the transaction process begins 633.

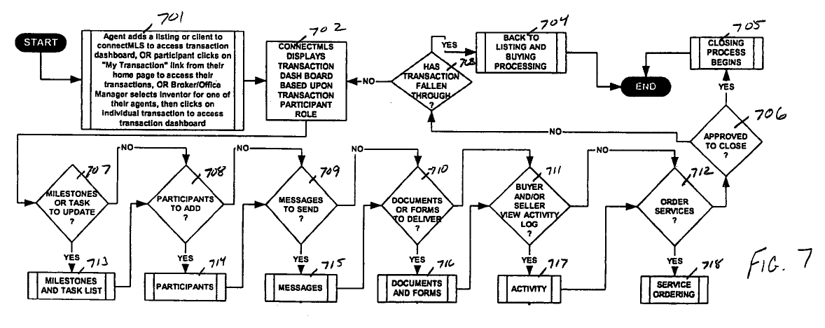

A method for managing a real estate transaction as a role-based transaction is illustrated in FIG. 7. The system provides a method for a participant to track, monitor and log milestones and tasks in the real estate transaction process from inception through post-closing activities 713. This feature is one of the most innovative and useful attributes of the invention. By providing the ability to track and log the development process, participants are afforded the opportunity in real-time to view the status of their transaction. The proposed method provides the participants with the ability to see the progress that has been made to date, as well as the items that need to be completed, in a list format. By providing a concise, consolidated list of the items required to complete the transaction, the present invention minimizes the confusion traditionally related to real estate transaction processes. Moreover, because each of the participants has access to the list, all of the participants are able to easily identify the critical next steps in the transaction. As a result, the present invention serves to guide the participants through the steps required to complete the transaction efficiently. This feature provides a significant advantage over the existing art.

New participants can be added to the transaction at any time 708. An unlimited number of other parties may participate including, for example, the buyer, the seller, their respective agents, a lender, a title company representative, or other vendors 714. In addition, messages can be sent to any of the participants in a transaction 709. The messages can be sent manually or automatically by any of the participants to one another and the system provides a method for automatic message notification 715. Participants can deliver documents to and from the system 710. In addition, the document owner decides which participants are permitted to view the documents 716. Transaction milestones are automatically updated when documents have been delivered to the system 716. Participants also have the ability to log and track the activity of the transaction 711. Any change to the listing or transaction is recorded and displayed in the activity log 717. Individual entries are restricted according to the role individual participants play in the transaction 717. The system also displays a listing hit counter corresponding to the number of times the listing has appeared in searches or been printed, shared or received interest from buyers 717. The system also provides a method for ordering services 712. Service orders are sent to and from participants according to their role in the transaction 718. Custom order options may be configured by service providers 718. Service order recipients can be added as a transaction participant as a part of the service ordering process 718. Transaction participants can also be notified of service order status 718. Service order forms are delivered electronically or integrated into a recipient order processing system 718. The progress of ordered services is tracked concurrently with the real estate transaction 718. Once the role-based transaction process is complete, the closing process begins 705.

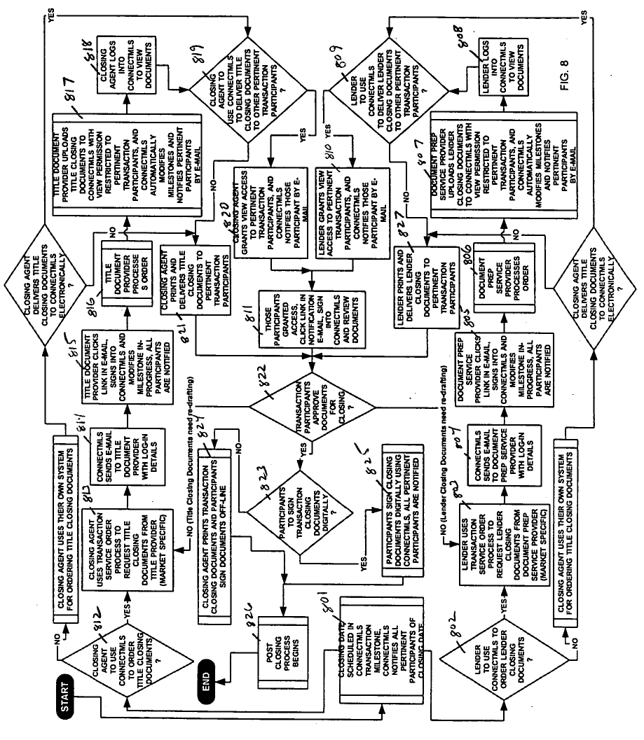

A method for managing the closing process is shown in FIG. 8. For example, an agent can order title closing documents 812. An agent may also use the transaction service order process to request title closing documents from a title provider 813. An email 814 can be sent to the title document provider with login details 815. The title document provider can process the order 816 and upload title closing documents to the system 817. The ability to view the title closing documents is restricted to the pertinent transaction participants and those participants are automatically notified by email 817. The seller's agent can login and view the title closing documents 818, print and deliver the title closing documents to the pertinent transaction participants in hard copy 821 or grant viewing access to the transaction participants 819 and notify them electronically such as, for example, by email that the documents are posted on the system 820. The participants can then click on a link in an email, sign into the system and review the documents 811. If the transaction participants approve the documents for closing 822 the participants can digitally sign the closing documents 823. In this context, digital signature means any signature or manifestation of assent transmitted electronically. At the same time, a closing date may be scheduled 801 and the lender can order lender closing documents 802. The lender may use the transaction service order process to request lender closing documents from document service provider 803. The system provides notification electronically such as, for example, by email to the document preparation service provider with login details 804. The document preparation service provider clicks on a link in the email, signs into the system and modifies the milestone which, in turn, automatically notifies all participants 805. Next, the document preparation service provider may process the order 806, modify milestones and upload lender closing documents into the system with view permission restricted to pertinent transaction participants 807. The pertinent transaction participants are then notified by email 807. Upon receiving the email, the lender logs into the system to view the documents 808. The lender then has the choice of delivering the lender closing documents to the other pertinent transaction participants 809 by printing and delivering the lender closing documents in hard copy 827 or by granting the pertinent transaction participants access to the system and notifying them by email 810. The participants who have been granted access can click on a link in the notification email, sign into the system and review these closing documents 811. Once the transaction is approved 822 and signed by both parties, either digitally 825 or by hand 824, the closing process ends and the post-closing process begins 826.

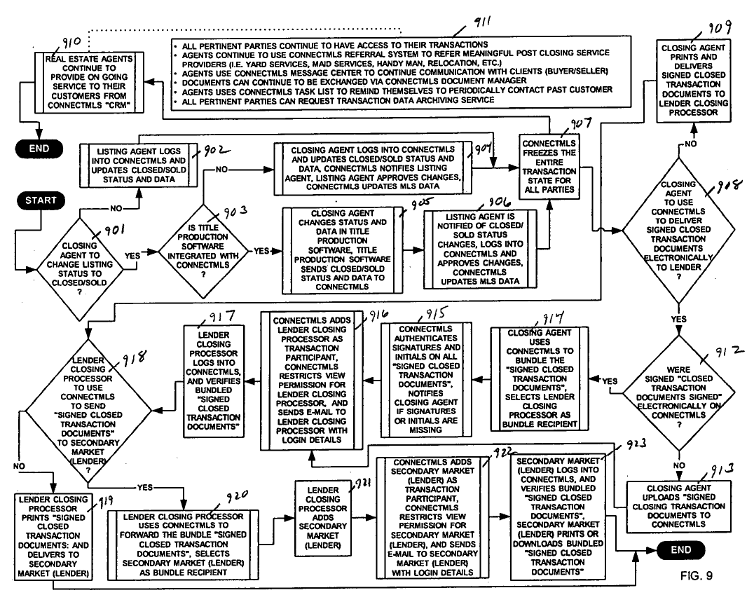

A method for managing the post-closing process is shown in FIG. 9. First, an agent can change the listing status of real estate to closed or sold 901. Once the status is changed, to closed or sold, the system freezes the entire transaction state for all parties 907. Parties continue to have access to their transaction and agent may continue to use the system to refer post-closing service providers to the buyer or seller 911. Signed closed transaction documents are delivered electronically to a lender 908. A participant can upload signed closing documents to the system 913 or if the signed closed transaction documents were signed electronically on the system, the agent can merely bundle these documents and grant the lender closing processor as a recipient 914. The signatures and initials on the signed closed transaction documents are authenticated and the agent is notified if the signatures or initials are missing 915. The lender closing processor is added as a transaction participant, view permission for the lender closing processor is restricted, and an email is sent to the lender closing processor with login details 916. The lending closing processor can then log into the system and verify the bundled signed closed transaction documents 917. The lender closing processor may then send signed closed transaction documents to secondary market lenders 918 by either printing the signed closing documents and delivering hard copies to secondary market lenders 919 or the lender closing processor can electronically forward the bundle signed closed transaction documents to selected secondary market lenders by designating them as bundle recipients 920. The secondary market lender can be added as a transaction participant so that the secondary market lender may have restricted viewing rights to view the documents 922. Secondary market lender may log into the system, verify the bundled, signed closed transaction documents and print them for review or filing or store them on their servers as soft copies 923.

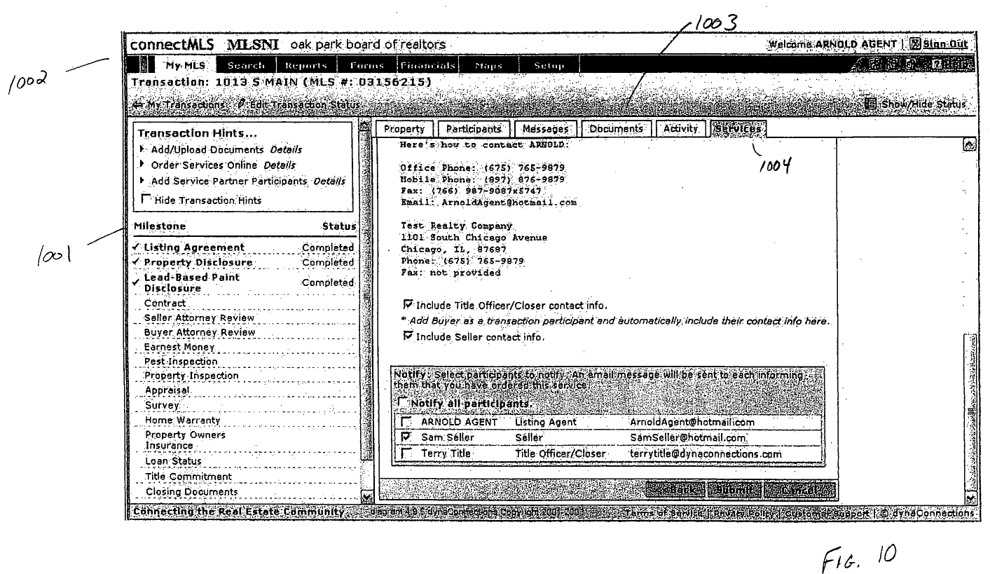

FIG. 10 is a diagram illustrating an embodiment of a screen shot generated as part of the listing process 102 of a multiple-listing system. In the screen shot, the user has instructed the browser to go to a designated URL as indicated by the address displayed in an address box. In this embodiment, information is provided to the user. The user may display the information by controlling the on-screen pointer in conjunction with an input device. The pointer may be controlled by the user using an input device such as a mouse, a track ball, a touch pad, a keyboard, or other device configured to allow the user to control the pointer.

The sidebar on the left side of the screen shot in FIG. 10 bears the heading “milestone” to signal a participant to the tracking of the development of a real estate transaction 1001. This is one embodiment of the task list described earlier that provides participant with a visual overview of the status of the transaction and serves as a guide for the completion of the remainder of the transaction. For example, a participant using this functionality can determine that milestones of a listing agreement, property disclosure and lead base paint disclosure have been completed. At the same time, a participant can determine a contract has not yet been completed. In addition, the tool bar tabs 1002 and window tabs 1003 are inherent in this graphical user interface. For example, the services tab 1004, highlighted on the right-portion of the screen, illustrates the services ordered for the current transaction. Using this functionality, a participant can immediately order services from a real estate service provider.

A method for integrating a real estate transaction management system into the existing transaction environment is shown in FIG. 1. Initially, an agreement is reached with the local real estate association or operators of the multiple listing system pursuant to which the real estate transaction management system is to be integrated into the existing multiple listing system 1101. The agreement may provide, for example, such requirements as the implementation schedule, the area to be served, and other information related to the operation of this system. Next, the real estate transaction management system is launched and the participants in the system begin paying the respective fees 1102. In connection with the real estate transaction management system, the owner of the system can provide a customizable embedded transaction management system that also generates revenue for the owner 1103. Specifically, money may be generated from the embedded transaction management system when real estate service providers upgrade from a basic, limited free service within the system to enhanced services within the system 1104. Real estate service providers on a national, regional or local scale may participate in the real estate transaction management system at an enhanced level 1105. Revenue received by the owner of the real estate transaction management system from the real estate service providers may be shared with the real estate associations or the operator of the multiple listing system in accordance with the terms of the agreement between the parties 1106. Because the real estate transaction management system serves as a platform through which service providers provide services and receive exposure, the system evolves into a strong, self-sustaining model.

Operation

A more detailed description of the present invention includes a system for comprehensively managing a real estate transaction which includes a real estate multiple-listing system, a system for managing real estate purchases, a system for managing real estate closings, a system for managing post-closing activities, and a method for accessing said real estate multiple-listing-system, said system for managing real estate purchases, said system for managing real estate closings, and said system for managing post-closing activities, through a network. The foregoing system may also include a method for granting access to a participant or a potential participant in a real estate transaction and include a method for accessing real estate-related vendor information. The foregoing system may also include a method for inputting information such as, for example, contact information of a participant or a potential participant in a real estate transaction. The foregoing system may also include a method for uploading information related to the transaction such as, for example, real estate-related information. The foregoing system may also contain a method for electronically delivering real estate-related information to a participant or a potential participant in a real estate transaction such as, for example, email. The real estate-related information may be, for example, referrals, vendor contacts, real estate listings, county property tax records, representation agreements, offers, offer agreements, inspection reports, lending documents, closing documents and related documents.

The foregoing system may also include a method for accessing a wide variety of real estate-related documents through a network. The foregoing system may also include a method for restricting access to real estate-related documents to certain transaction participants or potential participants. The foregoing system may also include a method for updating and modifying real estate-related documents through a network. The real estate-related documents may be, for example, listing agreements, agent representation agreements, offers, offer agreements, lending documents, closing documents or similar documents. The foregoing system may also include a method for electronically signing documents. The foregoing system may also include a method for automatically notifying a participant or a potential participant when real estate-related documents are modified. The foregoing system may also include a method for tracking, monitoring and logging the development of a real estate transaction. The foregoing system may also include a method for updating the status of the development of a real estate transaction. The foregoing system may also include a method for granting a participant or a potential participant in a real estate transaction access to a transaction activity log or other summary or list showing the status of the transaction. The foregoing system may also include a method for automatically notifying a participant or a potential participant in a real estate transaction when the status of the development of said real estate transaction is updated. The foregoing system may also include a method for ordering real estate-related services through a network. The foregoing system may also include a method for agents to generate new marketing leads. The foregoing system may also include a method for creating a private webpage for a buyer or a seller. The foregoing system may also include a method for posting information to a buyer or seller's private webpage. The foregoing system may also include a method for automatically notifying a buyer, a seller, or an agent when information is posted to a buyer or a seller's private webpage. The foregoing system may also include a method for a seller and an agent to interact through electronic communication while viewing information posted on said seller's private webpage. The foregoing system may also include a method for a buyer and an agent to interact through electronic communication while viewing information posted on said buyer's private webpage. The foregoing system may also include a method for an agent to conduct a comparable market analysis over a network. The foregoing system may also include a method for a buyer to contact lenders. The foregoing system may also include a method for buyer to apply for loans on-line. The foregoing system may also include a method for searching third party databases, such as MLS and county records for data related to the real property, such as property address and county tax data. The foregoing system may also include a method for an agent to define and save search criteria from a buyer's contact information. The foregoing system may also include a method for an agent to identify properties that match a buyer's criteria. The foregoing system may also include a method for routine automated searches for property that match a buyer's criteria. The foregoing system may also include a method for a buyer, a seller and their respective agents to access real estate-related documents through a network. The foregoing system may also include a method for a buyer, a seller and their respective agents to interact through electronic communication while accessing real estate-related documents through a network. The foregoing system may also include a method for automatically notifying a buyer, a seller, and their respective agents of electronic communication by said buyer, said seller or said agents. The foregoing system may also include a method for acquiring electronic copies of title closing documents from a title provider through a network. The foregoing system may also include a method for acquiring electronic copies of lender closing documents from a lender through a network. The foregoing system may also include a method for a method for providing information related to closed transactions to secondary mortgage lenders through a network.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

We claim:

1. A system for comprehensive real estate transaction management comprising:
a real estate multiple-listing system;
a system for managing real estate purchases;
a system for managing real estate closings;
a system for managing post-closing activities; and
a method for accessing said real estate multiple-listing system, said system for managing real estate purchases, said system for managing real estate closings, and said system for managing post-closing activities, through a network.

2. The system of claim 1 further including a method for granting a single access point to each of said real estate multiple listing system, said system for managing real estate purchases, said system for managing real estate closings, and said system for managing post-closing activities a participant or a potential participant in a real estate transaction.

3. The system of claim 1 further including a method for accessing real estate-related vendor information.

4. The system of claim 1 further including a method for inputting contact information of a participant or a potential participant in a real estate transaction.

5. The system of claim 1 further including a method for electronically uploading real estate-related information.

6. The system of claim 1 further including a method for electronically delivering real estate-related information to a participant or a potential participant in a real estate transaction.

7. The system of claim 6 wherein at least a portion of said real estate-related information is selected from the group consisting of referrals, vendor contacts, listings, county property records, tax records, representation agreements, offers, offer agreements, inspection reports, lending documents and closing documents.

8. The system of claim 1 further including a method for accessing real estate-related documents through said network.

9. The system of claim 1 further including a method for restricting access to real estate-related documents through a network to certain participants or potential participants in a real estate transaction.

10. The system of claim 1 further including a method for modifying real estate-related documents through said network.

11. The system of claim 10 wherein at least one of said real estate-related documents is selected from the group consisting of listing agreements, agent representation agreements, offers, offer agreements, lending documents and closing documents.

12. The system of claim 1 further including a method for electronically or digitally signing documents through said network.

13. The system of claim 1 further including a method for automatically notifying a participant or a potential participant in a real estate transaction when real estate-related documents are modified in a manner that affects said participant or potential participant.

14. The system of claim 13 wherein said real estate-related documents are selected from the group consisting of listing agreements, agent representation agreements, offers, offer agreements, lending documents and closing documents.

15. The system of claim 1 further including a method for tracking, monitoring and logging the progress of a real estate transaction.

16. The system of claim 1 further including a method for updating the status of the progress of a real estate transaction.

17. The system of claim 1 further including a method for granting a participant or a potential participant in a real estate transaction access to a transaction activity log.

18. The system of claim 1 further including a method for automatically notifying a participant or a potential participant in a real estate transaction when the status of the progress of said real estate transaction is updated.

19. The system of claim 1 further including a method for ordering real estate-related services through said network.

20. The system of claim 1 wherein said real estate multiple-listing system provides a method for agents to communicate with potential buyers.

21. The system of claim 1 wherein said real estate multiple-listing system provides a method for creating a private webpage for a buyer or a seller.

22. The system of claim 1 wherein said real estate multiple-listing system provides a method for posting information to a buyer or seller's private webpage.

23. The system of claim 1 wherein said real estate multiple-listing system provides a method for automatically notifying a buyer, a seller, or an agent when information is posted to a buyer or a seller's private webpage.

24. The system of claim 1 wherein said real estate multiple-listing system provides a method for a seller and an agent to interact through electronic communication while viewing information posted on said seller's private webpage.

25. The system of claim 1 wherein said real estate multiple-listing system provides a method for a buyer and an agent to interact through electronic communication while viewing information posted on said buyer's private webpage.

26. The system of claim 1 wherein said real estate multiple-listing system provides a method for an agent to conduct a comparable market analysis of a seller's or a potential seller's real estate.

27. The system of claim 1 wherein said real estate multiple-listing system provides a method for a buyer to contact referrers.

28. The system of claim 1 wherein said real estate multiple-listing system provides a method for a buyer to apply for loans through said network.

29. The system of claim 1 wherein said real estate multiple-listing system provides a method for searching MLS and county records for property address and county tax data.

30. The system of claim 1 wherein said real estate multiple-listing system provides a method for obtaining property addresses and county tax data.

31. The system of claim 1 wherein said real estate multiple-listing system provides a method for an agent to define and save search criteria from a buyer's contact information.

32. The system of claim 1 wherein said real estate multiple-listing system provides a method for an agent to identify properties that match a buyer's real estate selection criteria.

33. The system of claim 1 wherein said real estate multiple-listing system provides a method for routine automated searches for property that match a buyer's real estate selection criteria.

34. The system of claim 1 wherein said real estate multiple-listing system provides a method for the automated posting of real estate-related information to a buyer or a seller's private webpage.

35. The system of claim 1 wherein said system for managing real estate purchases provides a method for a buyer, a seller and their respective agents to access real estate-related documents through said network.

36. The system of claim 1 wherein said system for managing real estate purchases provides a method for a buyer, a seller and their respective agents to interact through electronic communication while accessing real estate-related documents through said network.

37. The system of claim 1 wherein said system for managing real estate purchases provides a method for automatically notifying a buyer, a seller, and their respective agents of electronic communication by said buyer, said seller or said agents.

38. The system of claim 1 wherein said system for managing real estate closings provides a method for acquiring electronic copies of title closing documents from a title provider through said network.

39. The system of claim 1 wherein said system for managing real estate closings provides a method for acquiring electronic copies of lender closing documents from a lender through said network.

40. The system of claim 1 wherein said system for managing post-closing activities provides a method for providing information related to closed transactions to secondary mortgage lenders through said network.

41. The system of claim 1 wherein at least a portion of the network is selected from the group consisting of the Internet, an intranet, a wireless network, a wide area network, a local area network and a point-to-point connection.

42. A method for comprehensive real estate transaction management comprising the steps of:
entering information relating to a property involved in a real estate transaction into a multiple listing system;
monitoring the progress of said real estate transaction through a network connected to said multiple listing system;
managing the closing of said real estate transaction over said network; and
managing the post-closing activities related to said real estate transaction over said network.

43. The method of claim 42 further comprising granting access to said multiple listing system to a participant or a potential participant in said real estate transaction.

44. The method of claim 42 further comprising accessing real estate-related vendor information through said network.

45. The method of claim 42 further comprising inputting contact information of a participant or a potential participant in said real estate transaction.

46. The method of claim 42 further comprising electronically uploading real estate-related information into said multiple listing system.

47. The method of claim 42 further comprising electronically delivering real estate-related information to a participant or a potential participant in said real estate transaction.

48. The method of claim 47 wherein said real estate-related information is selected from the group consisting of referrals, vendor contacts, listings, county property records, tax records, representation agreements, offers, offer agreements, inspection reports, lending documents and closing documents.

49. The method of claim 42 further comprising accessing real estate-related documents through said network.

50. The method of claim 42 further comprising restricting access to real estate-related documents through said network to certain participants or potential participants in said real estate transaction.

51. The method of claim 42 further comprising modifying real estate-related documents through said network.

52. The method of claim 50 wherein at least one of said real estate-related documents is selected from the group consisting of listing agreements, agent representation agreements, offers, offer agreements, lending documents and closing documents.

53. The method of claim 42 further comprising electronically or digitally signing documents through said network.

54. The method of claim 42 further comprising automatically notifying a participant or a potential participant in said real estate transaction when real estate-related documents are modified.

55. The method of claim 54 wherein at least one of said real estate-related documents is selected from the group consisting of listing agreements, agent representation agreements, offers, offer agreements, lending documents and closing documents.

56. The method of claim 42 further comprising tracking, monitoring and logging the progress of said real estate transaction.

57. The method of claim 42 further comprising updating the progress of said real estate transaction.

58. The method of claim 42 further comprising granting a participant or a potential participant in said real estate transaction access to a transaction activity log.

59. The method of claim 42 further comprising automatically notifying a participant or a potential participant in said real estate transaction when the progress of said real estate transaction is updated.

60. The method of claim 42 further comprising ordering real estate-related services through said network.

61. The method of claim 42 wherein said multiple-listing system provides a method for agents to communicate with potential buyers.

62. The method of claim 42 wherein said multiple-listing system provides a method for creating a private webpage for a buyer or a seller.

63. The method of claim 42 wherein said multiple-listing system provides a method for posting information to a buyer or seller's private webpage.

64. The method of claim 42 wherein said multiple-listing system provides a method for automatically notifying a buyer, a seller, or an agent when information is posted to a buyer or a seller's private webpage.

65. The method of claim 42 wherein said multiple-listing system provides a method for a seller and an agent to interact through electronic communication while viewing information posted on said seller's private webpage.

66. The method of claim 42 wherein said multiple-listing system provides a method for a buyer and an agent to interact through electronic communication while viewing information posted on said buyer's private webpage.

67. The method of claim 41 wherein said multiple-listing system provides a method for an agent to conduct a comparable market analysis of a seller's or a potential seller's real estate.

68. The method of claim 42 wherein said multiple-listings provides a method for a buyer to contact lenders.

69. The method of claim 42 wherein said multiple-listing system provides a method for a buyer to apply for loans on-line through said network.

70. The method of claim 42 wherein said multiple-listing system provides a method for searching MLS and county records for property address and county tax data.

71. The method of claim 42 wherein said multiple-listing system provides a method for obtaining property addresses and county tax data.

72. The method of claim 42 wherein said multiple-listing system provides a method for an agent to define and save search criteria from a buyer's contact information.

73. The method of claim 42 wherein said multiple-listing system provides a method for an agent to identify properties that match a buyer's real estate selection criteria.

74. The method of claim 42 wherein said multiple-listing system provides a method for routine automated searches for property that match a buyer's real estate selection criteria.

75. The method of claim 42 wherein said multiple-listing system provides a method for the automated posting of real estate-related information to a buyer or a seller's private webpage.

76. The method of claim 42 wherein said multiple listing service provides a method for a buyer, a seller and their respective agents to access real estate-related documents through said network.

77. The method of claim 42 wherein said multiple listing system provides a method for acquiring electronic copies of title closing documents from a title provider through said network.

78. The method of claim 42 wherein said multiple listing system provides a method for acquiring electronic copies of lender closing documents from a lender through said network.

79. The method of claim 42 wherein said multiple listing system provides a method for providing information related to closed transactions to secondary mortgage lenders through said network.

80. A method for comprehensive real estate transaction management comprising:
means for entering information relating to a property involved in a real estate transaction into a multiple listing system;
means for monitoring the progress of said real estate transaction through a network connected to said multiple listing system;
means for managing the closing of said real estate transaction over said network; and
means for managing the post-closing activities related to said real estate transaction over said network.

81. A method for comprehensive real estate transaction management comprising:
a multiple listing system, wherein said multiple listing system contains information related to the listing and sale of property within a defined geographic area and said multiple listing system is connected to a network;
listing a seller's property within said multiple listing system;
providing information relating to a buyer for said property into said multiple listing system, wherein said information relating to said property and said information relating to said buyer relate to at least one real estate transaction;
allowing at least one service provider to have access to said network to provide services related to said real estate transaction to said seller and said buyer; and
providing access to said seller, said buyer and said service provider over said network.

82. A method for comprehensive real estate transaction management comprising:
a multiple listing system, wherein said multiple listing system contains information related to the listing and sale of property within a defined geographic area and said multiple listing system is connected to a network;
listing a seller's property within said multiple listing system;
providing information relating to a buyer for said property into said multiple listing system, wherein said information relating to said property and said information relating to said buyer relate to at least one real estate transaction;
allowing at least one service provider to have access to said network to provide services related to said real estate transaction to said seller and said buyer; and
providing access to said seller, said buyer and said service provider over said network.

83. A method for comprehensive real estate transaction management comprising:
a real estate multiple listing system wherein real estate agents have access to information relating to properties for sale within a defined geographic area;
providing access to said real estate multiple listing system over a network;
providing parties that provide services related to the purchase or sale of real estate with access to said real estate multiple listing system over said network; and
when one of said properties within said real estate multiple listing system is under contract, providing a checklist of tasks that need to be completed by each of the parties involved in the transaction in order to complete the sale of said property.

84. A method for comprehensive real estate transaction management comprising:
a real estate multiple listing system wherein real estate agents have access to information relating to properties for sale within a defined geographic area;
providing access to said real estate multiple listing system over a network;
providing parties that provide services related to the purchase or sale of real estate with access to said real estate multiple listing system over said network;
when one of said properties within said real estate multiple listing system is under contract, providing access to information related to the sale of said property to limited parties, wherein said limited parties are one or more of said parties that provide services related to the purchase or sale of real estate who are designated by the seller and the buyer of said property; and
providing a checklist of tasks required to complete said sale of said property by the seller, the buyer and said limited parties.

85. A method for comprehensive real estate transaction management comprising:
a real estate multiple listing system wherein real estate agents have access to information relating to properties for sale within a defined geographic area;
means for providing access to said real estate multiple listing system over a network;
means for providing parties that provide services related to the purchase or sale of real estate with access to said real estate multiple listing system over said network;
when one of said properties within said real estate multiple listing system is under contract, means for providing access to information related to the sale of said property to limited parties, wherein said limited parties are one or more of said parties that provide services related to the purchase or sale of real estate who are designated by the seller and the buyer of said property; and
means for providing a checklist of tasks required to complete said sale of said property by the seller, the buyer and said limited parties.

86. A method for comprehensive real estate transaction management comprising:
a system for managing the listing and sale of real estate wherein real estate agents have access to information relating to properties for sale within a defined geographic area;
providing access to said system over a network;
allowing parties engaged in providing services to a seller of property listed within said system to have access to said system over said network;
when one of said properties within said system is under contract, allowing the buyer and the seller of said property to select services from said parties engaged in providing services; and
providing a checklist of those items required to be completed by said buyer, said seller, and said parties engaged in providing services in order to finalize said contract and complete the transaction contemplated thereby.

87. A method for comprehensive real estate transaction management comprising:
a system for managing the listing and sale of real estate wherein real estate agents have access to information relating to properties for sale within a defined geographic area;
providing access to said system over a network;
creating a checklist of tasks required to complete the sale of a property listed within said system wherein said checklist is available for viewing over said network by participants in said transaction.

88. A method for comprehensive real estate transaction management comprising:
a system for managing the listing and sale of real estate wherein real estate agents have access to information relating to properties for sale within a defined geographic area;
providing access to said system over a network;
allowing participants in the sale of a property listed within said system to have access to said system over said network; and
allowing said participants to complete the tasks required to close said sale of said property over said network.

89. A method for integrating a real estate services comprising:
a real estate multiple listing service;
a real estate transaction management service;
integrating said real estate multiple listing service with said real estate transaction management service wherein said real estate transaction management service is enabled to track, monitor and close transactions within said real estate multiple listing service; and
allowing real estate service providers to pay a fee to advertise and participate in said real estate transaction management service; thereby gaining exposure to the participants in said real estate multiple listing service.

90. A method for integrating a real estate services comprising:
a real estate multiple listing service;
a real estate transaction management service;
means for integrating said real estate multiple listing service with said real estate transaction management service wherein said real estate transaction management service is enabled to track, monitor and close transactions within said real estate multiple listing service; and
means for allowing real estate service providers to pay a fee to advertise and participate in said real estate transaction management service; thereby gaining exposure to the participants in said real estate multiple listing service.

91. A method for integrating a real estate services comprising:
a real estate multiple listing service;
a real estate transaction management service;
integrating said real estate multiple listing service with said real estate transaction management service wherein said real estate transaction management service is enabled to track, monitor and close transactions within said real estate multiple listing service;
allowing real estate service providers to pay a fee to advertise and participate in said real estate transaction management service; thereby gaining exposure to the participants in said real estate multiple listing service; and
providing a portion of said fee to the operator of said real estate multiple listing service.
